(19) United States
(12) Patent Application Publication
(10) Pub. No.: US 2006/0108788 A1
(43) Pub. Date: May 25, 2006

(54) Combination bookmark and notepad for compiling reader's notes and/or listing descriptions or common terms

(76) Inventor: Robert Jeffery Hendrickson, Godley, TX (US)

Correspondence Address: Robert Hendrickson, 14508 FM 2331, Godley, TX, 76044, US

(21) Appl. No.: 10/991,691

(22) Filed: Nov. 19, 2004

(51) Int. Cl. B42D 9/00

(52) U.S. Cl. 281/42

(57) ABSTRACT

A bookmark and notepad combination for various publications, such as books, magazines, trade and professional journals, educational text, catalog etc. Said bookmark and notepad combination includes a page marker spine backer with raised tab and extended back surface for an adhered notepad. The page marker spine backer is of a rigid substrate, with an extended top, left tab for page marking and an extended back glue surface area to adhere the notepad. The length and width dimensions of the bookmark and notepad combination preferably vary in size and correspond to the various size publications. The bookmark and notepad combination are from one-sixteenth of an inch thick up to one-half an inch thick depending on number of notepad pages. The reader can utilize the bookmark and notepad combination to mark desired reading locations in the publication as well as write notes onto the adhered notepad. The notepad can be pre-printed display various graphics and text.

### REFERENCES CITED [REFERENCED BY]

| Re34759 | October, 1994 | Boyette. | |
|---|---|---|---|
| 732527 | June, 1903 | Devlin | 281/38. |
| 4184699 | January, 1980 | Lowe, Jr. | |
| 4509759 | April, 1985 | Small | 283/56. |
| 4614364 | September, 1986 | Bortner | |
| 4618116 | October, 1986 | Hsi | 281/15 |
| 5022681 | June, 1991 | Penick | 281/15. |
| 5088770 | February, 1992 | McCrea. | |
| 5098127 | March, 1992 | Williamson et al. | 281/15. |
| 5382053 | January, 1995 | Tanaka. | |
| 5713606 | February, 1998 | Kleinberg | 281/42 |
| 6109205 | August, 2000 | Smith | 116/234 |
| 6328338 | December, 2001 | Sherman | 281/42 |
| 6446803 | September, 2002 | McKinney | 206/371 |
| 6481367 | November, 2002 | McCloskey | 116/235 |

### FIELD AND BACKGROUND OF THE INVENTION

The present invention is generally directed to bookmarks that a reader utilizes to mark their current page of reading, and note taking devices and techniques such as making margin notes, highlighting and external notepads, and for supplemental reference guides to common terms and descriptions for a book, educational text, magazine, trade or professional journal, catalog and like publications.

Readers, such as students, trainees and business researchers, etc., commonly make notes in the margins of the publication, ear mark the pages for future reference, highlight text areas within the body copy, or utilize marker sheets or common bookmarkers to reference areas of interest or their last read page. These techniques are ineffective in that the small pieces of paper used as placeholders are often lost, or the reader has to peruse the entire publication to locate particular margin notes. Some of the techniques such as the highlighting and margin notes are disruptive to the books appearance, quality and ultimately its value.

Readers also often utilize a note-taking supplement such as a notepad or notebook that is carried along with the publication to write down references, points-of-interest, or the individual's interpretations of the text. These note taking devices are effective in that they allow the reader easy access to their notes, but, ineffective in that they do not conjoin with the publication for easy transport and access.

Reader supplements such as dictionaries and common terms for use with publications are burdensome in that they add one more element for the reader to carry and store. In summary, none of the bookmark systems and note taking devices provides a convenient way to mark the reader's page, take notes and/or reference applicable terms for particular publications.

This apparatus of a bookmark and notepad combination is designed to overcome these and other drawbacks of conventional bookmarks and note taking devices. The bookmark and notepad combination, being a separate apparatus from the publication, allows the reader to mark the current area of reading as well as compile notes in one apparatus. The bookmark part of the combination allows the reader to mark the area of reading. The notepad part of the combination allows the reader to write and store notes according to the individual's needs. The notepad part of the combination, when printed with common terms or descriptions, aids the reader for use with a book, educational text, magazine, trade or professional journal, catalog and like publications. The bookmark and notepad combination is then stored or recourse for purposes of information.

### OBJECTS AND SUMMARY OF THE INVENTION

It is a principle object of the present invention to provide a bookmark and notepad combination for a book, educational text, magazine, trade or professional journal, catalog and like publications, which overcomes the drawbacks associated with conventional devices of this type and further offers a convenient means of storing book notes for later reference.

An object of the present invention is to provide a bookmark and notepad combination for use with various publications, which offers an area for reader to write individual publication reference information such as title, date, page numbers etc.

Another object of the bookmark and notepad combination for use with various publications is to provide an area for advertisement or graphics.

It is yet another object of the bookmark and notepad combination for use with various publications to provide convenient and ready descriptions or common terms for use with pre-determined publications.

It is yet another object of the bookmark and notepad combination for use with various publications to provide a bookmark.

It is yet another object of the bookmark and notepad combination for use with various publications to provide a multiple page note taking device that is uniformly convenient in size and adhered to the bookmark to combine two separate apparatuses into one.

Other objects and features of advantages will become apparent as the specification progresses and from the drawings.

### BRIEF DESCRIPTIONS OF THE DRAWINGS

The invention will be better understood and objects and unique characteristics set forth will become apparent when consideration is given to the following detailed description thereof. Such description makes reference to annexed drawings.

FIG. 1 is a schematic flat view of the combination bookmark and notepad in use marking the location of a page in a publication according to the present invention.

FIG. 2 is a schematic flat view of the combination bookmark and notepad without publication.

FIG. 3 is a schematic flat view of the bookmark backer without the adhered notepad.

FIG. 4 is a schematic flat view of the multiple page notebook booklet without the bookmark backer adhered.

FIG. 5 is a schematic perspective view of the multiple page notebook booklet without the bookmark backer adhered with the booklet open to spread format.

FIG. 6 is a schematic flat view of the top of the combination bookmark and notepad.

FIG. 6(a) is a schematic flat view of the top of the combination bookmark and notepad with the bookmark backer separated from the notepad booklet.

### DETAILED DESCRIPTION OF THE DRAWINGS

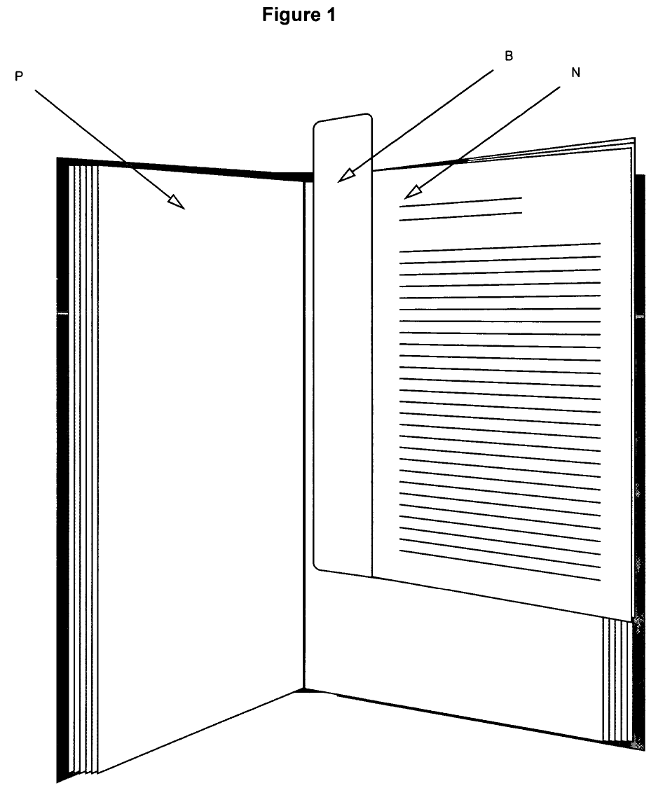

In referring to FIG. 1, the invention of a bookmark B and notepad N combination is shown marking a page within a publication P consisting of multiple stacked pages as shown. It is noted that publication P can be of any form, such as a book, magazine, trade or professional journal, catalog, brochure, newspaper, educational text or the like publication.

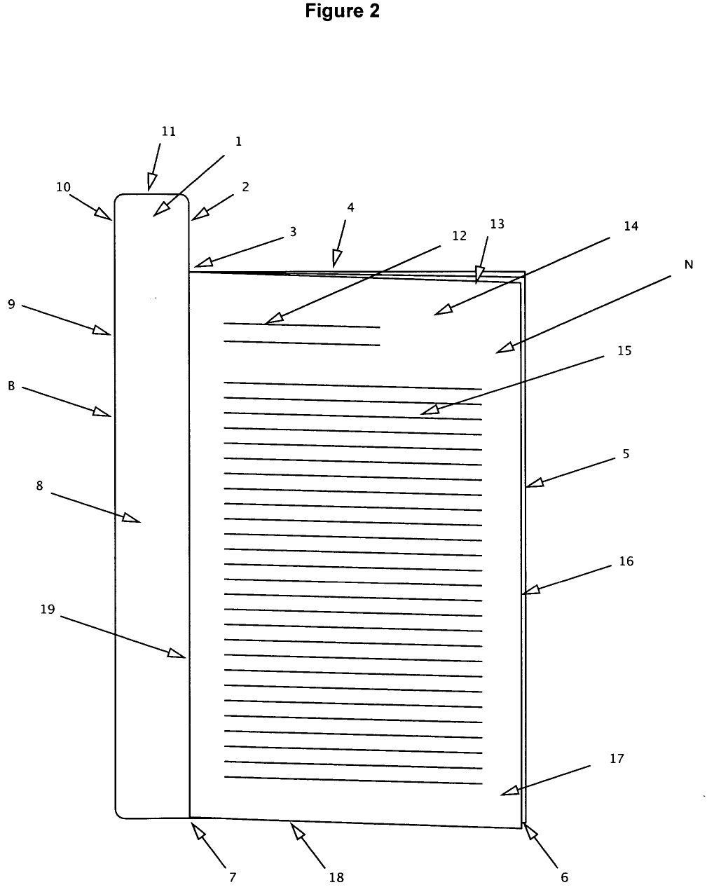

In referring to FIG. 2, the bookmark B consists of a left spine page marker 9, a raised tab 1 and an extended back 5. The bookmark B and notepad N intersect at the top elbow 3 of the spine page marker 9 and intersect at the bottom 7 of the spine page marker.

As also illustrated in FIG. 2, the notepad N has a configuration of folded sheets of paper with a left edge saddle stitched or perfect bound spine 19. The notepad N consists of multiple pages 16 that open to the right with generally straight top and bottom edges 13 and 18. The notepad N comprises of a folded sheet 14 with flat surface for indicia 12 and 15.

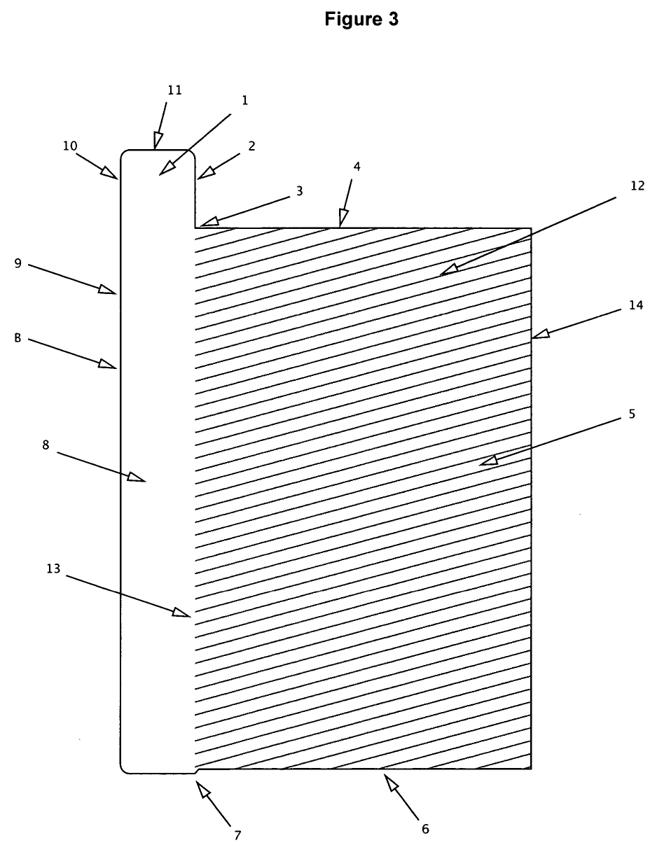

FIG. 3 shows closer detail of the bookmark B separate from the notepad. The bookmark B consists of a spine page marker 9 with a generally straight left edge 10 and a flat surface area 8. The raised tab 1 extends up along the left edge 10 with a top edge 11 and a right edge 2. The raised tab 1 intersects with the extended back 5 at the top elbow 3 and the bottom alignment elbow 7. The extended back 5 consists of a top edge 4, a bottom edge 6 and a right edge 14. The extended back 5 extends right from the spine page marker at the elbows 3 and 7. The extended back 5 has a flat glue surface area 12 with a coverage area that begins left 13 running parallel with the spine page marker flat surface 8 and stops at the top edge 4 right edge 14 and bottom edge 6 of the extended back 5.

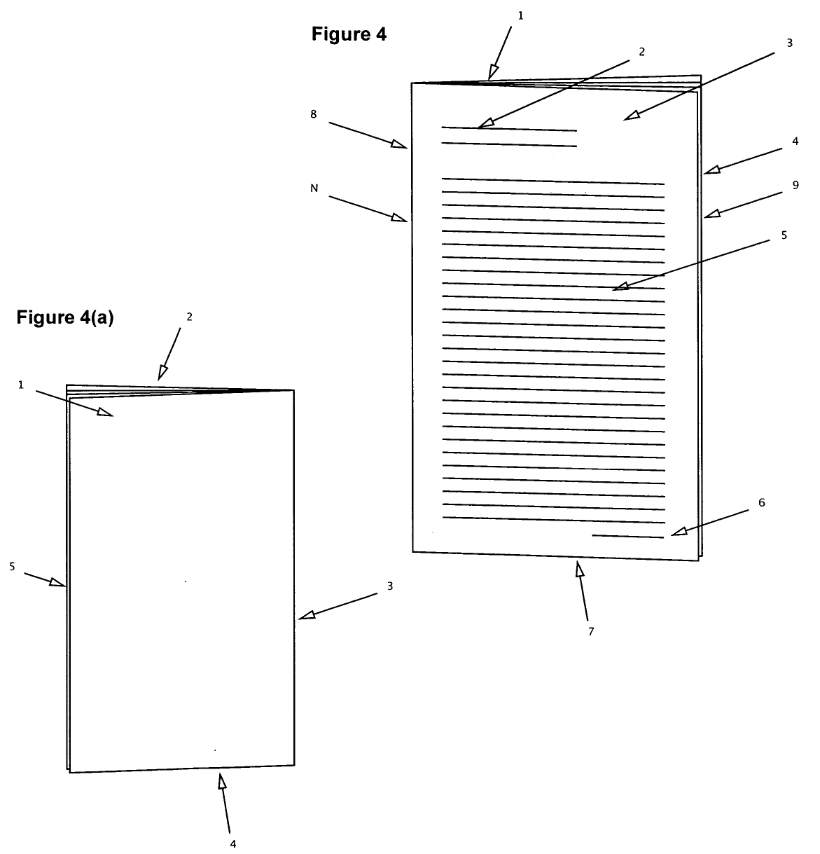

FIG. 4 shows closer detail of the front of the notepad N separate from the bookmark. The notepad N consists of multiple sheets of paper 9 generally folded in half and saddle stitched or perfect bound on the left edge at fold 8. The notebook consists of a top edge 1, a right edge opening 4 and a bottom edge 7.

The flat page surface 3 has printed indicia areas 2, 5 and 6.

FIG. 4(a) shows closer detail of the back of the notepad N separate from the bookmark. The flat page surface glue area consists of a top edge 2, folded spine edge 3 bottom edge 4 and left open edge 5. The flat page surface glue area is kept free from indicia for gluing purposes.

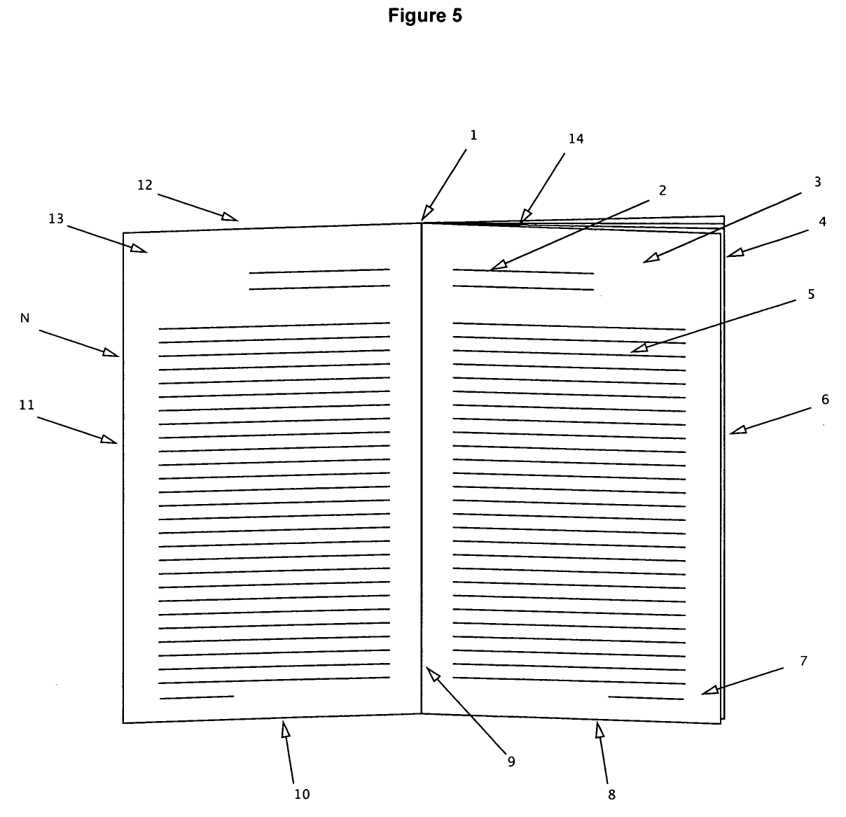

FIG. 5 shows closer detail of the inside of the notepad N separate from the bookmark with the notepad open to a left 13 and right 3 page spread. The notepad consists of multiple paper sheets folded in half 1 and 9. With the notepad open the notepad N consists of left 13 and right 3 hand facing pages. The left hand page 13 consists of a top edge 12, left edge 11, bottom edge 10. The right hand page 3 consists of a top edge 14, right edge 6, and bottom edge 8. 9 and 1 illustrate the fold area. The printed indicia lines 2 are for publication information and indicia lines 5 and 7 for reader notes and page numbers. The printed indicia lines 5 also represent the area for customized descriptions and common terms for various publications.

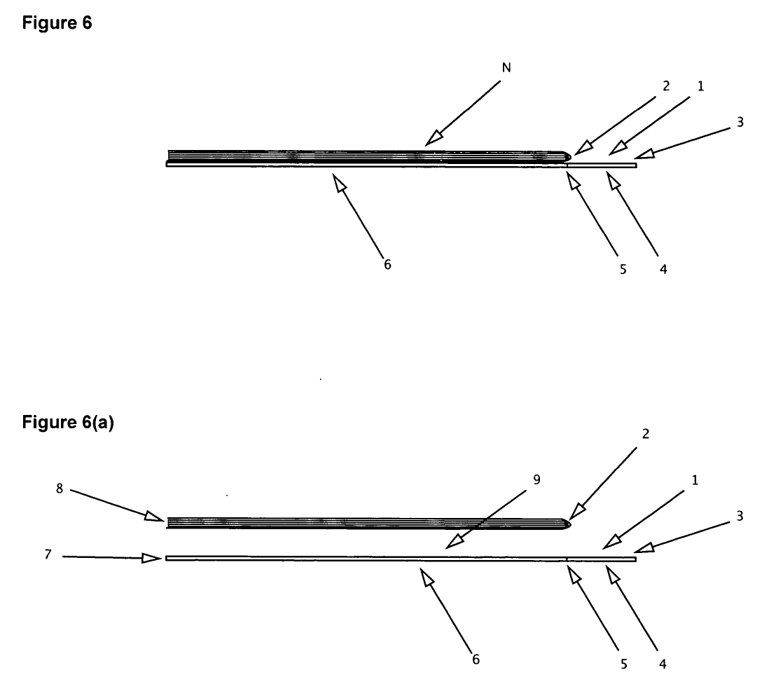

FIGS. 6 and 6(a) illustrates the bookmark B and notepad N combination from a top view. The bookmark B is a rigid material, usually polypropylene or PVC from 0.012 to 0.025 gauges thick. The bookmark B spine page marker 1 extends beyond the notepad N folded spine edge 2 which is also the left edge of the glue area 5. The spine page marker 1 left edge runs parallel with the left edge of the notepad 2. The back of the spine page marker 4 and the back of the extended back 6 is a flat surface.

7 illustrates the alignment of the right edge of the extended back 6 and the right edge of the notebook 8. The extended back glue surface area 9 is a flat surface for adhesive that extends from the right edge of the bookmark 7 to the left edge of the glue area 5.

In use (see FIG. 1), the reader marks the current pages by placing the bookmark B and notepad N combination in between the desired pages of the chosen publication P. As evident, by placing the bookmark and page combination toward the top of the publication, the raised tab 1 (see FIG. 2), the reader would be reminded of the last read page. Alternatively, as shown in FIG. 2, the reader has the notepad indicia lines 12 and 15 to take notes of the desired information from the publication. With notepad indicia lines, the user writes down the desired information on the pre-printed indicia lines. The related page numbers or name and date of text may be written in the appropriate fields. The pre-printed descriptions and/or common terms in association with predetermined publications is used by the reader as a supplement to the pre-determined publication. The bookmark and notepad combination of the invention therefore serves as a bookmark B for reader placement and notepad N for reader notes and reference.

While this invention has been described as having indicia lines and/or descriptions or common terms from pre-selected various publications, it is understood that it is capable of further modifications, uses and/or adaptations of the invention following in general the principle of the invention and including such departures from the present disclosure as come within known or customary practice in the art to which the invention pertains, and as may be applied to the essential features set forth, and fall within the scope of the invention or the limits of the descriptions.

I claim:

1. A bookmark and notepad combination comprising:
a) a single bookmark/page marker spine backer having front and back faces, top and bottom edges, left and right edges;
b) said bookmark/page marker spine backer including an extended spine edge on the left top corner;
c) a notepad having front and back faces, top and bottom edges, left and right edges;
d) said notepad consisting of multiple pages, folded and saddle stitched;
e) said notepad having a front and back cover;
f) wherein said notepad back cover is adhered to front face of said bookmark and aligned to the top, bottom and right edges keeping the bookmark sheet extended spine edge visible;
g) wherein said bookmark having exposed left edge from 0 inches up to 2 inches;

2. Said bookmark/page marker spine backer consisting of rigid material types of various grades, weights and colors;
a) Wherein said bookmark/page marker spine backer material types being of polypropylene, PVC, Vinyl or rigid pulp board stock or comparable material;
b) Wherein said bookmark/page marker spine backer having an extended left edge for the purpose of marking a publications page;
c) Wherein said extended left edge extends both to the left and the top;
d) Wherein said extended left edge can be die cut into various desired shapes;
e) Wherein said extended left edge used for the purpose of marking a publications page can be printed on front and back face;
f) Wherein said bookmark can be printed on back face;

3. Said notebook consisting of multiple pages, folded and saddle stitched in spine can be of various weights, grades and colors of paper;
a) Wherein said notebook paper can be printed on any front and back face;
b) Wherein said notebook can be die cut to various shapes;

4. The bookmark/page marker spine backer of claim 2, wherein:
a) said extended left edge can be free standing or stitched into the spine of a publication with a perforated line running parallel with publications spine and extending from top edge to bottom edge;
b) wherein the perforated line allows user to remove bookmark and notepad combination from the publication;

5. The notebook of claim 3, wherein:
a) The notepad can be printed to contain information from publication;
b) The notepad can have an indicia printing of area to inscribe information;
